(19) United States
(12) Patent Application Publication
(10) Pub. No.: US 2018/0215404 A1
(43) Pub. Date: Aug. 2, 2018

(54) ELECTRIC PUSH CART

(71) Applicant: MAKITA CORPORATION, Anjo-shi (JP)

(72) Inventors: Katsuna HAYASHI, Anjo-shi (JP); Kouichi TAKEDA, Anjo-shi (JP)

(73) Assignee: MAKITA CORPORATION, Anjo-shi (JP)

(21) Appl. No.: 15/854,966

(22) Filed: Dec. 27, 2017

(30) Foreign Application Priority Data
Jan. 31, 2017 (JP) 2017-015602

(51) Int. Cl. B62B 5/00; B62B 5/04; B60L 3/06

(52) U.S. Cl. CPC B62B 5/0073; B62B 5/004; B62B 5/0043; B62B 5/06; B60L 3/06; B62B 5/0053; B62B 5/0404

(57) ABSTRACT

An electric push cart includes a motor; a drive wheel that is rotationally driven by the motor; a cart frame that rotatably supports the drive wheel and includes left and right handles for a user to hold; a controller that drives the motor and issues a warning. The controller issues a warning when a motor-stop condition is fulfilled as a result of an increase in load on the motor when driving the motor and stops the drive of the motor after a given time has elapsed.

### CROSS-REFERENCE TO RELATED APPLICATIONS

This application claims the benefit of Japanese Patent Application No. 2017-015602 filed Jan. 31, 2017 in the Japan Patent Office, the entire disclosure of which is incorporated herein by reference.

### BACKGROUND

The present disclosure relates to an electric push cart that includes a wheel that can be driven by a motor.

An electric cart that includes a wheel (drive wheel) that can be driven by a motor, and a controller that rotates the drive wheel by driving the motor in accordance with a command from an operation device operated by a user is known as one of push carts (for example, see Japanese Unexamined Patent Application Publication No. 2011-079510).

### SUMMARY

In an electric push cart configured as described above, a wheel can be rotated by delivering current to a motor. This helps enable the user to easily perform a carrying task by holding the handles and pushing the cart.

An electric power device powered by a motor is usually configured to stop the drive of the motor to protect the motor when the motor is in an excessive-load state.

A controller of the electric push cart may also be configured to determine that a condition to stop the motor (motor-stop condition) is fulfilled and to stop the drive of the motor when the motor is in the excessive-load state.

However, if the drive of the motor is immediately stopped by such a protective function when, for example, the user is performing a carrying task with the electric push cart on a slope, the load of the cart is suddenly imposed on the user. In this case, the user may fail to hold the weight of the cart and bring the cart down.

It is desirable that one aspect of the present disclosure is an electric push cart that can notify a user before stopping the drive of a motor when a motor-stop condition is fulfilled by an increase in load on the motor.

The electric push cart in one aspect of the present disclosure includes a motor; a drive wheel that is rotationally driven by the motor; a cart frame that is configured to rotatably support the drive wheel and includes a right and a left handle for a user to hold in a rear end of the cart frame; and a controller that drives the motor.

The controller is configured to issue a warning in response to fulfillment of the motor-stop condition by an increase in load on the motor when driving the motor and stops the drive of the motor after a given time has elapsed.

As explained above, the electric push cart in the present disclosure first issues a warning and notifies the user that the drive of the motor will be stopped and then stops the drive of the motor instead of immediately stopping the drive of the motor in response to fulfillment of the motor-stop condition.

The user can therefore be aware of and ready for a stop of the drive of the motor before the drive of the motor is actually stopped. For example, when the drive of the motor is stopped in response to fulfillment of the motor-stop condition during a carrying task on a slope, the user can anticipate that the weight of the cart will be placed on him and take a defensive posture or manipulate a mechanical brake. According to the present disclosure, usefulness of the electric push cart can therefore be improved.

The controller may be configured to detect a loaded state of the motor based on at least one of a state of current conduction to the motor, a rotating state of the motor, or a temperature of the motor, and determine whether the motor-stop condition is fulfilled.

The controller may be configured to determine whether to execute a brake control, which produces damping torque on the drive wheel, depending on the rotating state of the when stopping the drive of the motor in response to fulfillment of the motor-stop condition.

This configuration can reduce the load imposed on the user by producing the damping torque on the drive wheel by the brake control when the drive of the motor is stopped during a carrying task on a slope. The usefulness of the electric push cart can therefore be further improved.

The controller may be configured to execute the brake control in a case where the rotational speed of the motor is equal to or less than a specified threshold value when stopping the drive of the motor in response to fulfillment of the motor-stop condition.

The controller may be configured to immediately stop the drive of the motor in response to fulfillment of an emergency motor-stop condition when driving the motor.

This configuration, which immediately stops the drive of the motor in response to fulfillment of the emergency motor-stop condition, can enhance the safety of the electric push cart. The emergency motor-stop condition may be, for example, a malfunction in the drive system of the motor such as a sensor and a power source for driving the motor.

### BRIEF DESCRIPTION OF THE DRAWINGS

An example embodiment of the present disclosure will be described hereinafter with reference to the accompanying drawings, in which:

FIG. 1 is a perspective view showing a configuration of a main part of an electric push cart in an embodiment;

FIG. 2A is a perspective view showing that a container, specifically a container that is made of pipes, is attached to the electric push cart shown in FIG. 1;

FIG. 2B is a perspective view showing that a container, specifically a container that is formed by pressing a metallic plate, is attached to the electric push cart shown in FIG. 1;

FIG. 3 is a plan view of a battery box arranged between right and left handles, taken from a top angle of the electric push cart;

FIG. 4 is a perspective view showing an exterior of an operation device disposed in the right handle;

FIG. 5 is a plan view of a battery box shown in FIG. 3 with its lid open;

FIG. 6 is a circuit block diagram showing an entire electric system of the electric push cart in the embodiment;

FIG. 7A is a block diagram showing a detailed configuration of the circuit block diagram, particularly of the operation device, shown in FIG. 6;

FIG. 7B is a circuit diagram showing a detailed configuration of the circuit block diagram, particularly of a backward flow prevention elements configuring a regenerative current preventer, shown in FIG. 6.

FIG. 7C is a circuit diagram showing a detailed configuration of the circuit block diagram, particularly of switching elements configuring an inverter, shown in FIG. 6;

FIG. 8 is a flowchart showing a motor control process; and

FIG. 9 is a flowchart showing an electric brake control process.

### DETAILED DESCRIPTION OF THE PREFERRED EMBODIMENTS

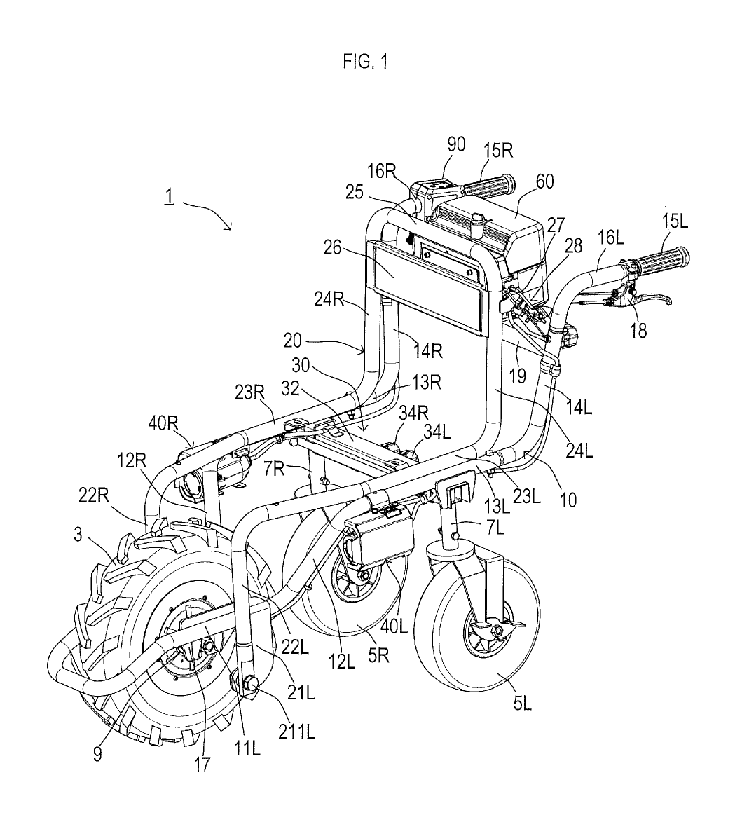

As shown in FIG. 1, an electric push cart 1 (hereinafter referred to as the cart 1) of the present embodiment is a three-wheel cart that includes a front wheel 3, which is one example of a drive wheel, and two rear wheels 5L and 5R, which are one examples of coupled driving wheels.

The letter “L” in the wheel 5L means “left” (indicating that the wheel is disposed on the left side of the cart 1 when viewed from the rear to the front of the cart 1); the letter “R” in the wheel 5R means “right” (indicating that the wheel is disposed on the right side of the cart 1 when viewed from the rear to the front of the cart 1). Other letters “L” and “R” used in the explanation hereinafter likewise mean the left and right.

The cart 1 includes a cart frame 10 that rotatably supports the wheels 3, 5L, and 5R; and a container support frame 20 that serves to fix a container for carrying loads onto the cart frame 10.

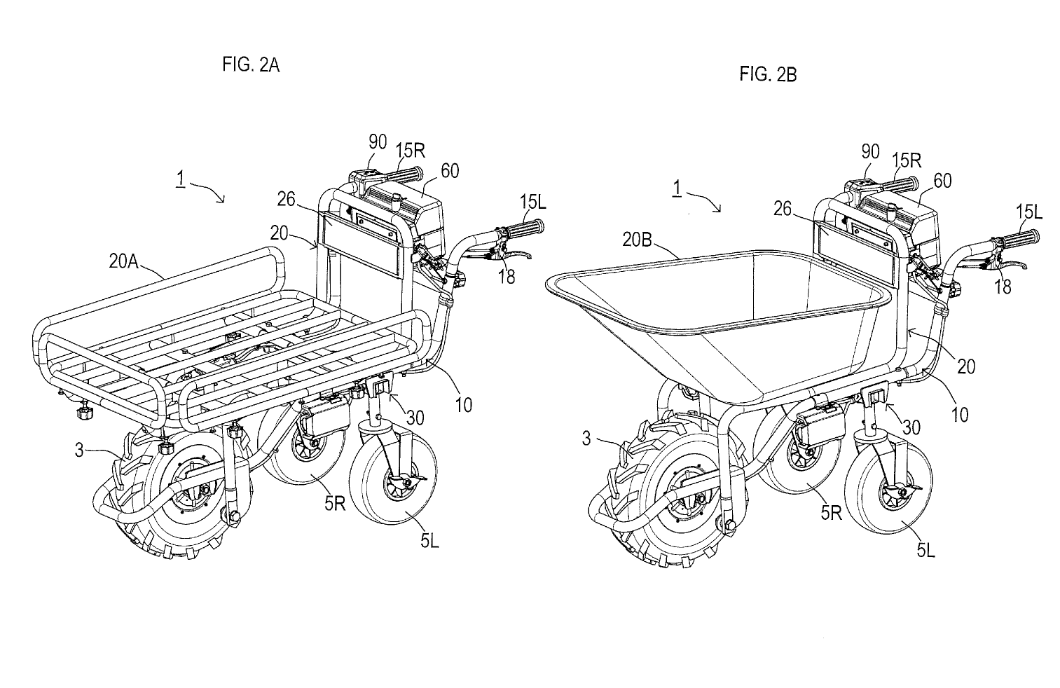

The container support frame 20 is configured to fix different types of containers, such as a container 20A designed as a so-called pallet by coupling pipes as shown in FIG. 2A and a container 20B designed as a so-called bucket by pressing a steel plate as shown in FIG. 2B. The user who performs a carrying task can select a container suitable for the task.

The cart frame 10 and the container support frame 20 are made from metallic pipe materials. Each of the frames 10 and 20 is formed by bending rod-shaped pipes such that the pipes are arranged symmetrically on the right and left sides of the cart 1 about the rolling surface of the front wheel 3.

The cart frame 10 includes a U-shaped curve that is bent around the front wheel 3 at the front end of the cart 1. The cart frame 10 includes front wheel supports 11L and 11R (FIG. 1 shows the front wheel support 11L on the left side) disposed at the rear sides of the U-shaped curve. The front wheel supports 11L and 11R hold the central part of the front wheel 3, which is the center of rotation of the front wheel 3, from the left and right of the cart 1 respectively and hold a motor 9 that is assembled to the central part of the front wheel 3. The front wheel 3 is thus rotatably fixed to the front wheel supports 11L and 11R and rotationally driven when current is delivered to the motor 9.

The cart frame 10 also includes inclined parts 12L and 12R that are respectively formed in the rear sides of the front wheel supports 11L and 11R. The inclined parts 12L and 12R spread apart from the front wheel 3 to the left and right sides of the cart 1 respectively and extend obliquely upwardly.

The cart frame 10 further includes left and right mounts 13L and 13R respectively formed in the rear sides of the inclined parts 12L and 12R. The mounts 13L and 13R are arranged substantially horizontally and serve to carry the container support frame 20.

A rear wheel frame 30 is disposed between these left and right mounts 13L and 13R. The rear wheel frame 30 is configured to carry the container support frame 20 and support the left and right rear wheels 5L and 5R.

The rear wheel frame 30 includes a frame body 32, and attachments 34L and 34R. The frame body 32 serves to fix rear wheel supports 7L and 7R, to which the left and right rear wheels 5L and 5R are respectively rotatably fixed, so that these rear wheel supports 7L and 7R can slide in the right-left directions of the cart 1. The attachments 34L and 34R serve to position and fix the rear wheel supports 7L and 7R respectively to the frame body 32. The user is thus free to determine the distance between the rear wheels 5L and 5R.

The cart frame 10 further includes inclined parts 14L and 14R respectively formed in the rear sides of the mounts 13L and 13R where the rear wheel frame 30 is disposed. The inclined parts 14L and 14R extend obliquely upwardly to the height that allows the user to push the cart 1.

The cart frame 10 further includes handles 16L and 16R respectively formed in the rear sides of the inclined parts 14L and 14R. The handles 16L and 16R are arranged substantially horizontally and include, in their rear ends, grips 15L and 15R respectively for the user to hold.

A brake device 17 is disposed in the left front wheel support 11L of the cart frame 10. The brake device 17 provides a damping force on the front wheel 3. A brake lever 18 is disposed on the left handle 16L. The brake lever 18 is configured to manually cause the brake device 17 to operate.

An operation device 90 is disposed on the right handle 16R of the cart frame 10. The operation device 90 is configured to perform functions such as setting the drive condition of the motor 9 and inputting a command to drive the motor 9.

Lighting devices 40L and 40R are disposed respectively on the left and right mounts 13L and 13R of the cart frame 10 for carrying the container support frame 20. The lighting devices 40L and 40R are configured to illuminate the area ahead from both left and right sides of the cart 1. The lighting devices 40L and 40R are so-called LED lights using LEDs as the light source.

The cart frame 10 includes a fixing frame 19 that is configured to fix a battery box 60 thereto between the inclined parts 14L and 14R. The battery box 60 is configured to house two battery packs that are power sources for the cart 1. The battery box 60 is fixed to the fixing frame 19 so as to be placed between the left and right handles 16L and 16R.

Attachments 21L and 21R are respectively fixed to the front wheel supports 11L and 11R of the cart frame 10 (FIG. 1 shows the attachment 21L on the left side). Left and right front ends of the container support frame 20 are respectively rotatably fixed to the attachments 21L and 21R at left and right pivots 211L and 211R (FIG. 1 shows the left pivot 211L) in an area below the center of rotation of the front wheel 3 such that the container support frame 20 can rotate over the front wheel 3.

The container support frame 20 includes connectors 22L and 22R. When the container support frame 20 is carried on the cart frame 10, the connectors 22L and 22R extend substantially vertically from the left and right pivots 211L and 211R where the container support frame 20 is fixed to the attachments 21L and 21R, to the height that is higher than the height of the front wheel 3 and allows the container support frame 20 to be carried on the mounts 13L and 13R of the cart frame 10.

The upper ends of the connectors 22L and 22R are bent at substantially right angle towards the mounts 13L and 13R of the cart frame 10 respectively. The container support frame 20 also includes container fixing parts 23L and 23R. The container fixing parts 23L and 23R are configured to be able to be carried on the mounts 13L and 13R of the cart frame 10.

The container fixing parts 23L and 23R are bent vertically upwardly in front of the inclined parts 14L and 14R of the cart frame 10. Upper ends of standing portions 24L and 24R are coupled to each other via a connector 25 at substantially the same height as the position of the battery box 60.

A protective cover 26 is disposed between the standing portion 24L and 24R. The protective cover 26 is situated below the connector 25 and serves to reduce contact of the loads carried on the containers 20A and 20B with the battery box 60.

Since the container support frame 20 is disposed to be rotatable over the front wheel 3 about the left and right pivots 211L and 211R on the attachments 21L and 21R, the user can lift the container support frame 20 at the connector 25 and tilt the container that is fixed to the container fixing parts 23L and 23R forward.

The user can drop carried objects in front of the cart 1 as necessary. However, if the container support frame 20 is not fixed to the cart frame 10, the container support frame 20 may be displaced vertically when the cart 1 is moved.

To avoid such displacement, an engaging member 28 is disposed on the fixing frame 19 of the cart frame 10 where the battery box 60 is fixed. The engaging member 28 is configured to engage with a hook 27, which is disposed on the left standing portion 24L of the container support frame 20, and fix the container support frame 20. The engaging member 28 includes a control lever for the user to manually control the engagement and disengagement with the hook 27.

The operation device 90 and the battery box 60 will be explained next. The operation device 90 is disposed on the right handle 16R of the cart frame 10 and configured for driving the motor. The battery box 60 is disposed between the left and right handles 16L and 16R.

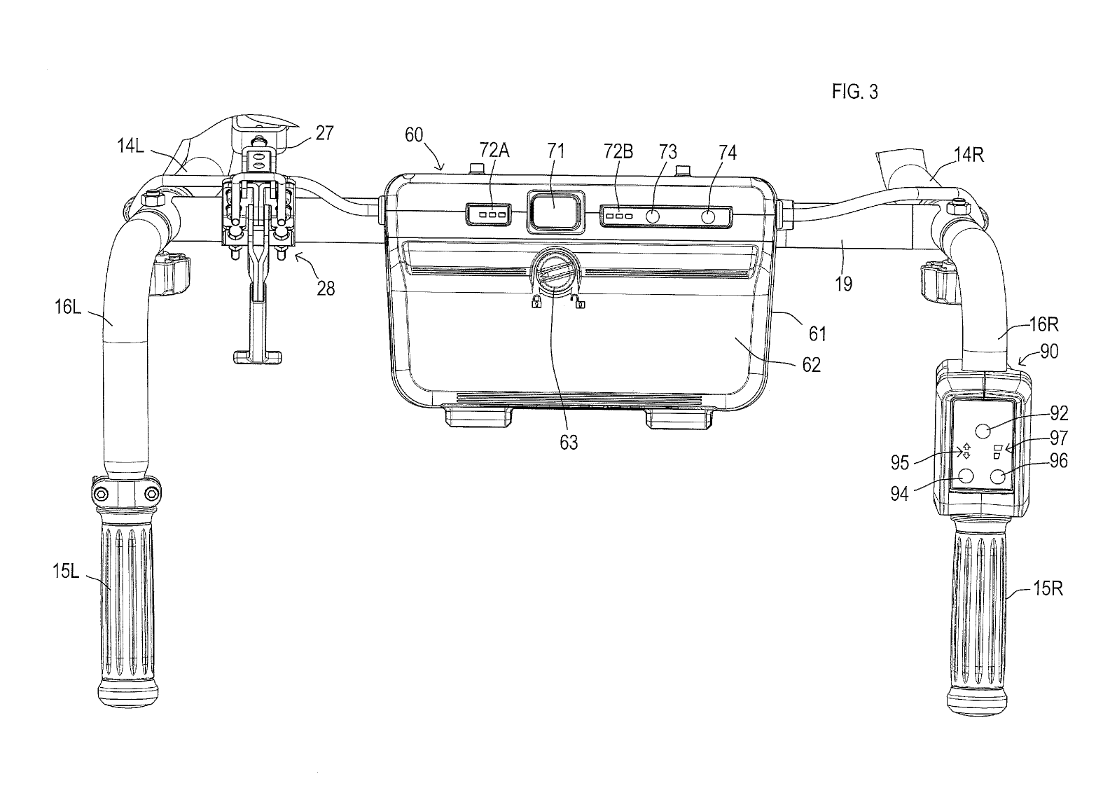

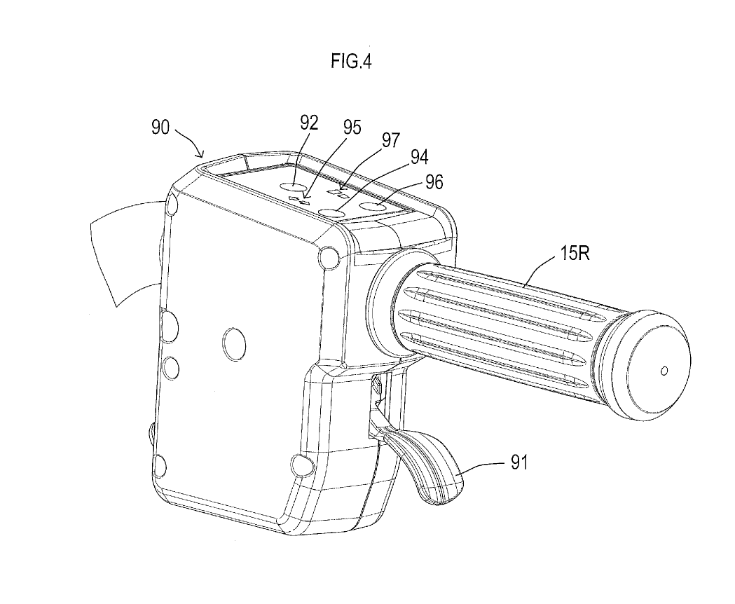

As shown in FIG. 3 and FIG. 4, the operation device 90 includes a case that can be attached to the handle 16R. A drive lever 91 and a main power switch 92 are assembled in the case.

The main power switch 92 is disposed on the top surface of the case.

The drive lever 91 is a so-called trigger that is configured to be manipulated by the user with his fingers while the user is holding the grip 15R and to issue a command designating a rotational speed of the motor 9 (in other words, travelling speed of the cart 1) in accordance with the amount of trigger manipulation. The drive lever 91 protrudes rearward from the lower part of the case.

The top surface of the case where the main power switch 92 is disposed also includes a forward-reverse selector switch 94; a forward-reverse direction display 95; a high-low speed selector switch 96; and a high-low speed display 97.

The forward-reverse selector switch 94 is configured to set the travelling direction of the cart 1 to either forward or reverse. The travelling direction of the cart 1 (more specifically, the direction of rotation of the motor 9) is changed every time the forward-reverse selector switch 94 is manipulated (pressed).

The forward-reverse direction display 95 is configured to display the travelling direction of the cart 1, which is set by the forward-reverse selector switch 94, by turning on either a forward arrow or a reverse arrow using LED lights, for example.

The high-low speed selector switch 96 is configured to set the speed mode of the motor 9 (in other words, speed mode of the cart 1) to either high speed of low speed. The speed mode is changed every time the high-low speed selector switch 96 is manipulated (pressed).

The speed mode includes two modes for setting the upper limit of the rotational speed of the motor 9 in accordance with the amount that the drive lever 91 is manipulated: a first mode that sets the upper limit to the preset high speed, and a second mode that sets the upper limit to the preset low speed. The rotational speed of the motor 9 is determined by multiplying the upper limit of the rotational speed preset in the speed mode by a ratio corresponding to the amount that the drive lever 91 is manipulated.

The high-low speed display 97 is configured to display the speed mode (high speed or low speed), which is set by the high-low speed selector switch 96, in two levels by lighting a two-level indicator using LED lights, for example.

In the present embodiment, the main power switch 92, the forward-reverse selector switch 94, the forward-reverse direction display 95, the high-low speed selector switch 96, and the high-low speed display 97 are assembled on a single substrate to facilitate the manufacture of the operation device 90.

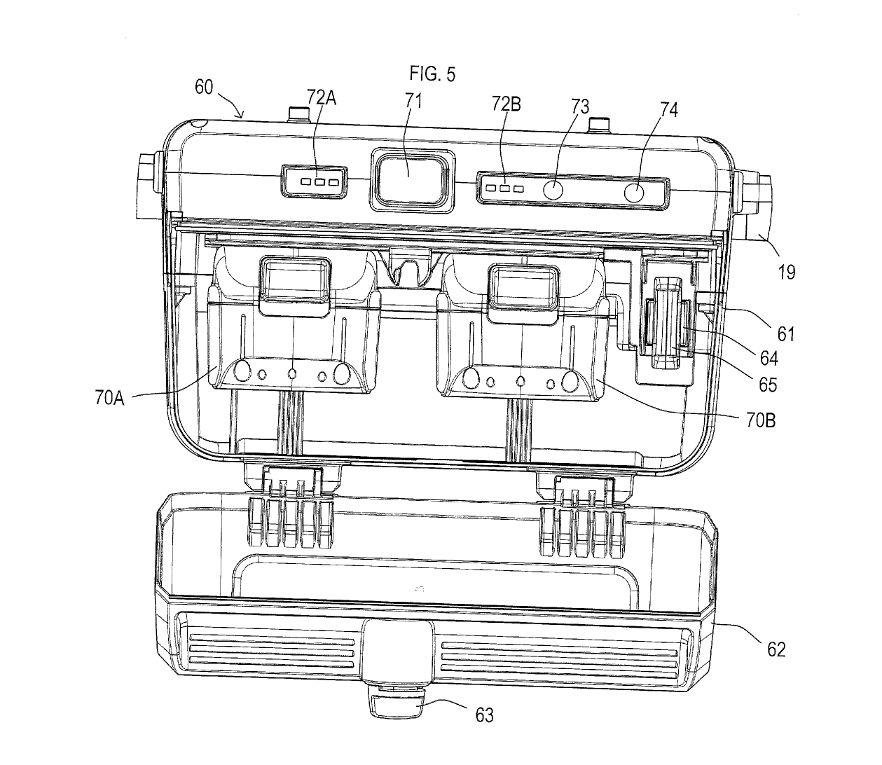

As shown in FIG. 3 and FIG. 5, the battery box 60 includes a box body 61 with an open top, and a lid 62 that opens and closes the top of the box body 61 so as to house two battery packs 70A and 70B (see FIG. 5).

The lid 62 is attached to the box body 61 with hinges and opens and closes on the hinges. An unhinged end of the lid 62 opposite to the hinged end includes a lock mechanism 63 that serves to fix the closed lid 62 to the box body 61.

The lock mechanism 63 can change the lock state between locked and unlocked by being rotated between locked and unlocked positions.

A portion of the top of the box body 61 is closed so as not to hamper the opening and closing movement of the lid 62. This closed portion includes a battery selector switch 71, and remaining energy displays 72A and 72B.

The battery selector switch 71 is configured to change the battery pack that is used as the power source between the battery packs 70A and 70B in response to the user changing the selection on the battery selector switch 71. The battery selector switch 71 is disposed between the housing spaces for the battery packs 70A and 70B. The user thus can confirm the battery pack that is used as the power source by looking at the selection on the battery selector switch 71.

The remaining energy displays 72A and 72B are configured to display the amount of electric energy stored (hereinafter referred to as the remaining energy) in the battery packs 70A and 70B respectively. In the present embodiment, the remaining energy displays 72A and 72B each include three LED lights arranged in a line and are configured to indicate the remaining energy by the number of the LED lights turned on.

These two remaining energy displays 72A and 72B are assembled to a first and second substrates and disposed near the housing spaces of the corresponding battery packs 70A and 70B respectively and arranged opposite to each other across the battery selector switch 71.

The second substrate where the remaining energy display 72B is assembled includes a remaining energy display switch 73 that is configured to issue a command to display the remaining energy, and a light switch 74 that is configured to issue a command to turn on and off the lighting devices 40L and 40R.

In response to the command to display the remaining energy from the remaining energy display switch 73, a control circuit 81, which will be explained later, causes the remaining energy displays 72A and 72B to display the remaining energy in the battery packs 70A and 70B respectively for a given length of time regardless of the selection on the battery selector switch 71.

If only one of the two housing spaces for the battery packs 70A and 70B in the battery box 60 is occupied by a battery pack, the remaining energy of the stored battery pack is displayed on the remaining energy display 72A or 72B that corresponds to the occupied housing space.

In the present embodiment, if one battery pack is stored in the battery box 60, the stored battery pack can be used to drive the motor 9 by selecting the occupied housing space by the battery selector switch 71.

A circuit board 80 is stored inside the closed portion of the battery box 60 where the components such as the battery selector switch 71 and the remaining energy displays 72A and 72B are disposed. The control circuit 81 for driving the devices such as the motor 9 and lighting devices 40L and 40R is assembled to the circuit board 80.

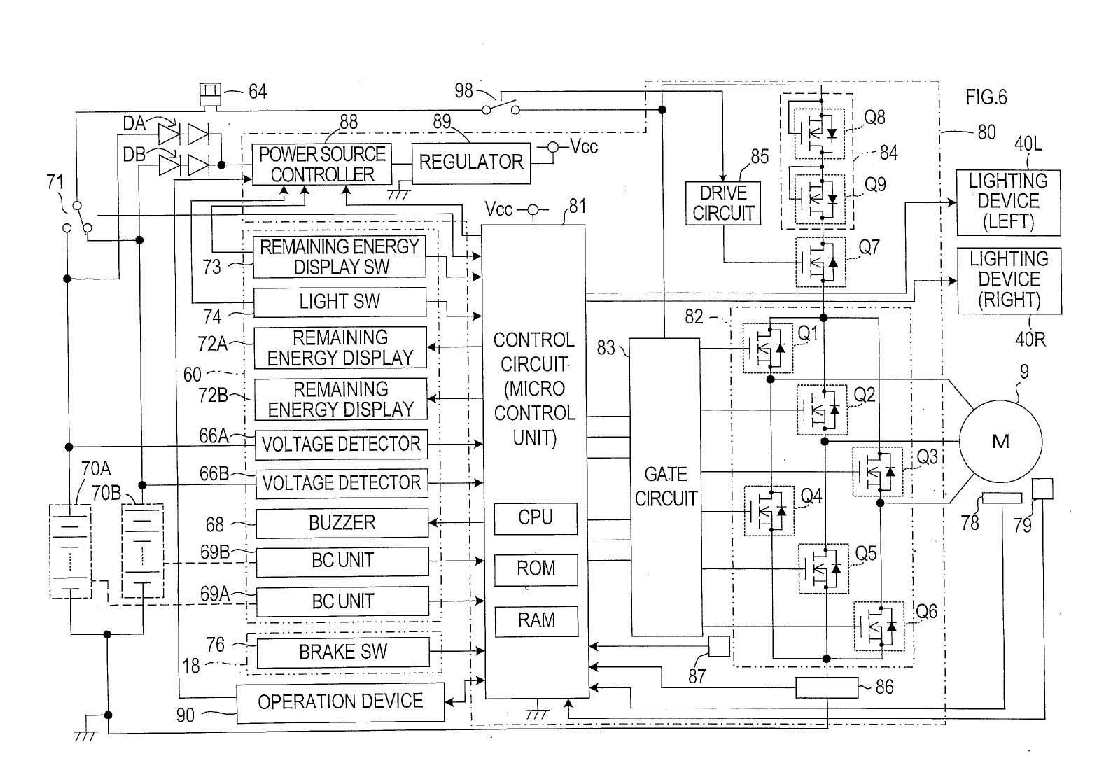

As shown in FIG. 6, the circuit board 80 includes an inverter 82; a gate circuit 83; a regenerative current preventer 84; a drive circuit 85; a current detector 86; an element-temperature detector 87; a power source controller 88; and a regulator 89, in addition to the control circuit 81.

The inverter 82 is configured to be supplied with electricity from the battery pack 70A or 70B stored in the battery box 60 and deliver the drive current to the motor 9. In the present embodiment, since the motor 9 is a three-phase brushless motor, the inverter 82 is configured with a three-phase full-bridge circuit including six switching elements Q1 to Q6.

Three of the switching elements in the inverter 82, Q1 to Q3, are disposed between the positive current path that is coupled to the positive side of the battery pack 70A or 70B and three (first, second, and third) terminals of the motor 9 respectively as so-called high-side switches.

The other three of the switching elements, Q4 to Q6, are disposed between the negative current path that is coupled to the negative side of the battery pack 70A or 70B and the three (first, second, and third) terminals of the motor 9 respectively as so-called low-side switches.

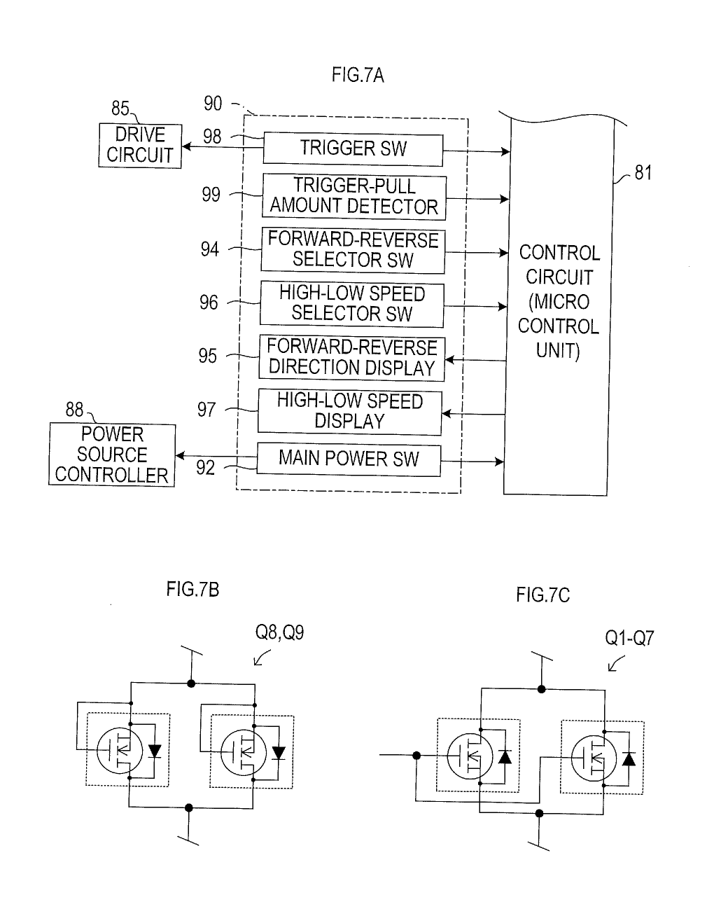

As shown in FIG. 7C, the switching elements Q1 to Q6 each include two n-channel MOSFETs connected in parallel. Each of the switching elements Q1 to Q6 can accordingly divide the drive current that flows through the motor 9 to two FETs and reduce the heat generated by the flow of the drive current.

The positive current path is coupled to the positive side of the battery pack 70A or 70B via the battery selector switch 71. The positive current path from the battery selector switch 71 to the inverter 82 includes a key slot 64 and a trigger switch 98.

As shown in FIG. 5, the key slot 64 is disposed inside the box body 61 of the battery box 60. As the key 65 is inserted into the key slot 64, the positive current path is closed and completed by the conductive part of the key 65. In addition, the trigger switch 98 is configured to be placed in the on-state when the drive lever 91 (so-called trigger) that is disposed in the operation device 90 is manipulated by the user.

The positive current path from the battery pack 70A or 70B to the inverter 82 (thus to the motor 9) is therefore completed and enables the motor 9 to be driven when the key 65 is inserted in the key slot 64 and the drive lever 91 is manipulated by the user.

The gate circuit 83 supplies electric current to each of the phase windings in the motor 9 and causes the motor 9 to be rotated by turning on and off the switching elements Q1 to Q6 in the inverter 82 in accordance with a control signal delivered from the control circuit 81.

The regenerative current preventer 84 is disposed in the positive current path from the trigger switch 98 to the inverter 82 to prevent regenerative current from flowing from the inverter 82 to the positive side of the battery pack 70A or 70B.

The regenerative current preventer 84 is configured to reduce backward flow of electric current and usually includes a diode for preventing the backward flow. In the present embodiment, switching elements Q8 and Q9, which are the same elements as the switching elements Q1 to Q6 in the inverter 82, are used as elements to prevent the backward flow.

As shown in FIG. 7B, the switching elements Q8 and Q9 each include two n-channel MOSFETs connected in parallel and configured to prevent the regenerative current from flowing by a parasitic diode disposed on each FET.

For this reason, the switching elements Q8 and Q9 are connected to the positive current path with anodes of the parasitic diodes on the positive side and cathodes of the parasitic diodes on the negative side, reversely of the switching elements Q1 to Q6 in the inverter 82, so that the drive current of the motor 9 flows in the forward direction.

As described above, the switching elements Q8 and Q9 each include two FETs connected in parallel with each other in the regenerative current preventer 84. The reason for this configuration is to reduce heat generation in each of the switching elements Q8 and Q9 by dividing the drive current of the motor 9 into two FETs.

The switching elements Q8 and Q9 are arranged in series in the positive current path in the regenerative current preventer 84. The reason for this arrangement is to prevent the regenerative current from flowing by one of the switching elements Q8 or Q9 when the other one experiences a short-circuit fault.

The drive circuit 85 is configured to place a switching element Q7 in the on-state when the trigger switch 98 is in the on-state. The switching element Q7 is disposed in the positive current path between the regenerative current preventer 84 and the inverter 82.

When the trigger switch 98 is placed in the off-state to interrupt the positive current path, the positive current path can be interrupted more confidently by also placing the switching element Q7 in the off-state. Similar to the switching elements Q1 to Q6 in the inverter 82, the switching element Q7 also includes two MOSFETs to reduce heat generation.

The current detector 86 is disposed in the negative current path from the inverter 82 to the negative sides of the battery packs 70A and 70B and configured to detect the drive current of the motor 9. The current detector 86 includes a shunt resistor that serves as a current detecting element.

The element-temperature detector 87 is configured to detect a temperature of the inverter 82 (more specifically, temperatures of the switching elements Q1 to Q6 included in the inverter 82) and includes a temperature detecting element such as a thermistor.

Detection signals from the current detector 86 and the element-temperature detector 87 are delivered to the control circuit 81.

The motor 9 includes detectors such as a rotational-position detector 78 for detecting a rotational position (angle) of the motor 9 and a motor-temperature detector 79 for detecting a temperature of the motor 9. Detection signals from these detectors 78 and 79 are also delivered to the control circuit 81.

The power source controller 88 is configured to receive battery power directly from the positive sides of the battery pack 70A and 70B via diodes DA and DB respectively and supply the received power to the regulator 89.

The reason for coupling the battery packs 70A and 70B directly to the power source controller 88 via the diodes DA and DB is to enable the power supply to the regulator 89 when the key 65 is removed from the key slot 64 and the current path to the motor 9 is interrupted.

The diodes DA and DB each include two semiconductor elements that serve as diodes for preventing backward flow and are connected in series with their anodes on the positive sides of the battery packs 70A and 70B and cathodes on the side of (towards) the power source controller 88.

The reason for this configuration is that, when one of the two semiconductor elements included in the diode DA (or DB) experiences a short-circuit fault, charging current is still prevented from flowing from the battery pack 70B (or 70A) to the battery pack 70A (or 70B) through the semiconductor element experiencing the short-circuit fault.

The power source controller 88 is configured to interrupt the supply of the battery power to the regulator 89 in accordance with a command from the control circuit 81. The power source controller 88 is also configured to start the supply of the battery power to the regulator 89 in response to a signal that is delivered from one of the remaining energy display switch 73 in the battery box 60, the light switch 74 in the battery box 60, or the main power switch 92 in the operation device 90 upon the user's manipulation.

The regulator 89 is configured to use the battery power thus supplied by the power source controller 88 to generate a power source voltage (direct current constant voltage) Vcc, which is for causing the control circuit 81 and peripheral circuits to perform, and supply the Vcc to each of these circuits.

The control circuit 81 can therefore stop its own operation by sending a command to the power source controller 88 to cause the supply of the power source from the regulator 89 to stop when the control circuit 81 is in operation. When the control circuit 81 is not in operation, the user can manipulate the main power switch 92, the remaining energy display switch 73, or the light switch 74 to activate the control circuit 81 to cause the control circuit 81 to execute corresponding controls.

The control circuit 81 is configured with an MCU (Micro Control Unit) that includes a CPU, an ROM, and an RAM as its main components. The control circuit 81 controls the drive current that flows to the motor 9 via the gate circuit 83 to control the rotational speed and the direction of rotation of the motor 9.

The control circuit 81 also performs functions such as turning on and off the lighting devices 40L and 40, displaying the remaining energy on the remaining energy displays 72A and 72B, and displaying the travelling direction and the set speed respectively on the forward-reverse direction display 95 and the high-low speed display 97 in the operation device 90.

The control circuit 81 is therefore coupled to displays and switches that are disposed in the lighting devices 40L and 40R, the battery box 60, and the operation device 90, in addition to being coupled to the rotational-position detector 78, the motor-temperature detector 79, the gate circuit 83, the current detector 86, the element-temperature detector 87, and the power source controller 88.

More specifically, the control circuit 81 is coupled to the remaining energy displays 72A and 72B, the remaining energy display switch 73, and the light switch 74 that are disposed in the battery box 60, and also receives a signal to indicate the selected battery pack from the battery selector switch 71.

As shown in FIG. 7A, the control circuit 81 is also coupled to the main power switch 92, the forward-reverse selector switch 94, the forward-reverse direction display 95, the high-low speed selector switch 96, the high-low speed display 97, and the trigger switch 98 that are disposed in the operation device 90.

As shown in FIG. 6, the battery box 60 includes voltage detectors 66A and 66B that are configured to detect output voltages (more specifically, battery voltages) from the battery packs 70A and 70B respectively, and a buzzer 68 that is configured to generate a notification sound when a malfunction occurs. In addition to the batteries, the battery packs 70A and 70B respectively include built-in battery communication units 69A and 69B that are configured to notify battery condition. In FIG. 6, the battery communication units are abbreviated to “BC UNIT”.

The brake lever 18 includes a brake switch 76 that is configured to be placed in the on-state when the brake lever 18 is being manipulated (in other words, when the brake device 17 is in operation). As shown in FIG. 7A, the operation device 90 also includes a trigger-pull amount detector 99 that detects the amount of trigger manipulation (amount of trigger pull) of the drive lever 91.

The control circuit 81 is thus coupled to the voltage detectors 66A and 66B, the buzzer 68, the battery communication units 69A and 69B, the brake switch 76, and the trigger-pull amount detector 99.

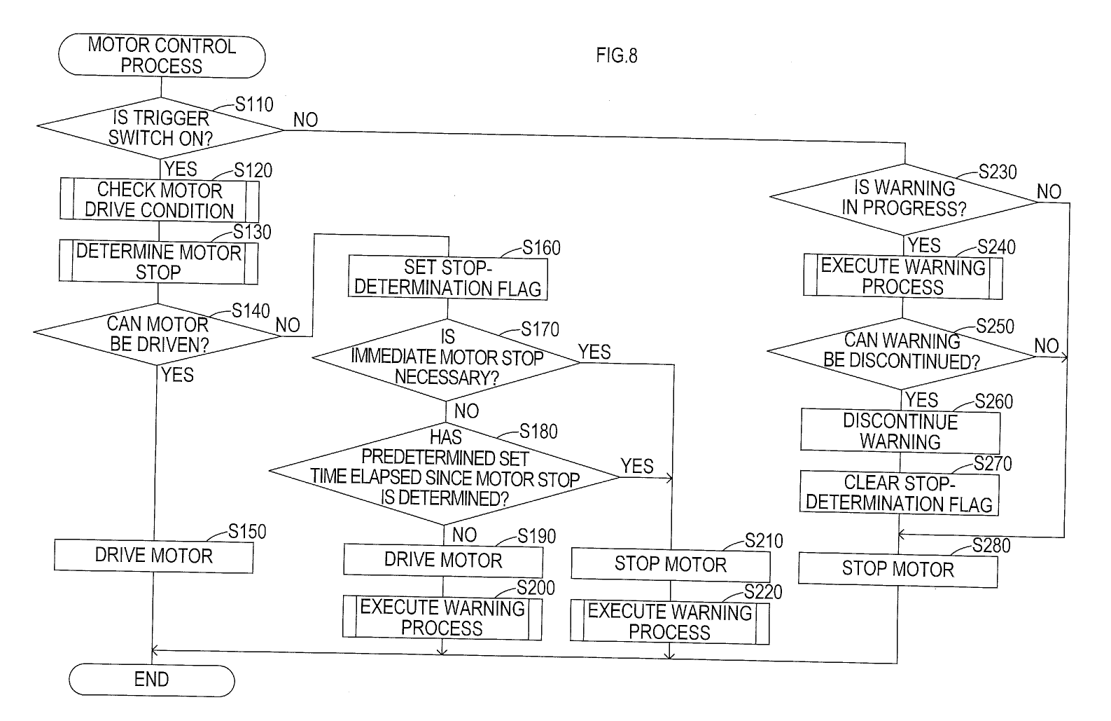

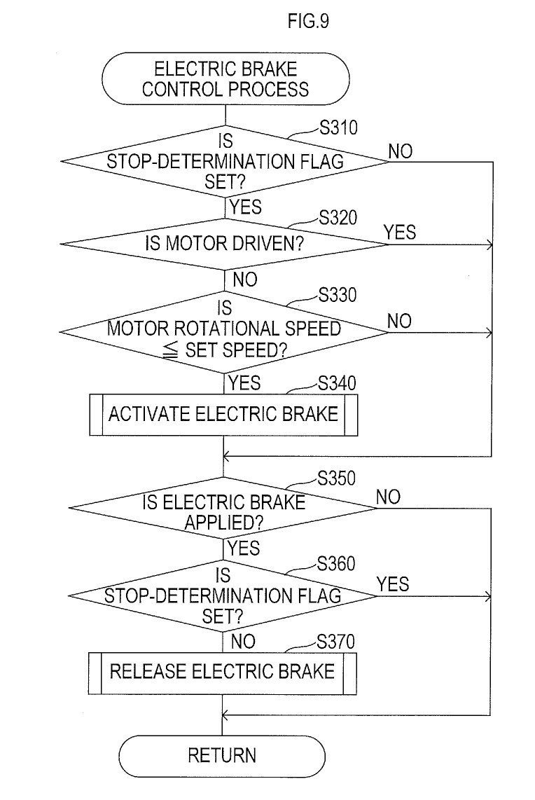

The control circuit 81 repeatedly performs a motor control process shown in FIG. 8 and an electric brake control process shown in FIG. 9 at a given interval as one of its main routine when the control circuit 81 is activated by the power source supplied by the regulator 89.

The motor control process is for controlling the drive of the motor 9 in accordance with input signals from the aforementioned variety of switches or detection signals from the aforementioned variety of detectors. The electric brake control process is for determining whether to produce damping torque in the motor 9 by a so-called short brake or to let the motor be in a free-run state and accordingly executing the determined control when stopping the drive of the motor 9 in the motor control process.

The motor control process and the electric brake control process will be explained hereinafter.

In the motor control process, as shown in FIG. 8, the process first determines in S110 whether the trigger switch 98 is placed in the on-state by the user's manipulation of the drive lever 91. The process proceeds to S120 if the trigger switch 98 is placed in the on-state; or the process proceeds to S230 if the trigger switch 98 is placed in the off-state.

In S120, the process determines whether the drive condition of the motor 9, which is that the brake switch 76 is in the off-state, is fulfilled.

In the subsequent S130, the process determines whether the motor-stop condition is fulfilled based on input signals from, for example, the battery communication units 69A and 69B, the voltage detectors 66A and 66B, the battery selector switch 71, the current detector 86, the element-temperature detector 87, the rotational-position detector 78, and the motor-temperature detector 79.

More specifically, the process detects temperatures of the motor 9 and the inverter 82 as well as the electric current that flow to the motor 9 and its voltage (state of current conduction to the motor 9) based on the aforementioned various input signals and detects the loaded state of the motor 9 based on factors such as the rotational speed of the motor 9. The process then determines that the motor-stop condition to protect the motor 9 is fulfilled if the motor 9 is in an excessive-load state.

In S130, the process determines whether a malfunction has occurred, for example, in the battery pack 70A or 70B that is selected by the battery selector switch 71 and in a sensor in the components such as the rotational-position detector 78 based on the aforementioned various input signals. In an occurrence of such a malfunction, the process then determines whether the emergency motor-stop condition to immediately stop the motor 9 is fulfilled.

In S140, the process then determines whether the motor 9 can be driven at the current moment based on the determinations made in S120 and S130. In S140, the process determines that the motor 9 can be driven when it is determined in S120 that the drive condition of the motor 9 is fulfilled and it is determined in S130 that the emergency motor-stop condition or the motor-stop condition of the motor 9 is not fulfilled.

If it is determined in S140 that the motor 9 can be driven, the process then proceeds to S150 and executes a drive control to drive the motor 9 and ends the motor control process. In this drive control, the direction of rotation and the rotational speed of the motor 9 are set based on the speed mode that is set by the high-low speed selector switch 96, the travelling direction that is set by the forward-reverse selector switch 94, and the amount of manipulation of the drive lever 91 that is detected by the trigger-pull amount detector 99. The drive control then controls the current conducted to the motor 9 via the gate circuit 83 and the inverter 82 to meet the set direction of rotation and the set rotational speed.

If it is determined in S140 that the motor 9 cannot be driven, the process then sets a stop-determination flag in S160, and determines in the subsequent S170 whether the motor 9 needs to be immediately stopped. In S170, the process determines whether the emergency motor-stop condition of the motor 9 is fulfilled based on the determination made in S130.

If it is determined in S170 that the emergency motor-stop condition is fulfilled and the motor 9 needs to be immediately stopped, the process proceeds to S210 and executes a stop process that interrupts the current conduction to the motor 9 to stop the drive of the motor 9.

In the subsequent S220, the process executes a warning process that notifies the user that the drive of the motor 9 is stopped and ends the motor control process. This warning process is configured, for example, to sound a buzzer 68 at a specified warning pattern and turn on and off the remaining energy displays 72A and 72B at a specified warning pattern.

If it is determined otherwise in S170 that the emergency motor-stop condition of the motor 9 is not fulfilled and the motor 9 does not need to be immediately stopped, the process proceeds to S180 and determines whether a predetermined set time has elapsed since the process determined that the stop condition of the motor 9 was fulfilled in S130.

If the predetermined set time has elapsed, the process proceeds to S210. If the predetermined set time has not elapsed, the process proceeds to S190 to continue the drive of the motor 9 by executing the same drive control of the motor 9 as executed in S150.

In the subsequent S200, the process executes the warning process to notify the user that the drive of the motor 9 will be stopped and ends the motor control process. The warning process in S200 is for pre-notifying the user of the stop of the drive of the motor 9. Thus, the length of the set time used in the determination in S180 is only required to be long enough to issue a warning sound to notify the user that the drive of the motor 9 will be stopped. The length of the set time is therefore should be a few seconds (for example, about 3 seconds).

The warning process in S200 may be executed in the same manner as executed in S220, or, it may alternatively be configured to sound the buzzer 68 and turn on and off the remaining energy displays 72A and 72B at a warning pattern different from S220. The warning processes in S200 and S220 may include turning on and off of the lighting devices 40L and 40R.

If it is determined in S110 that the trigger switch 98 is placed in the off-state, the process proceeds to S230 and determines whether the user is currently notified of the stop of the drive of the motor 9 by the warning process in S200 or S220, in other words, whether the warning is being issued. If the warning is being issued, the process proceeds to S240 to continue to warn the user by the same warning process as executed in S200 or S220 and then proceeds to S250.

In S250, the process determines whether the warning to the user can be discontinued. This determination is made based on, for example, an input signal from the brake switch 76; if the brake lever 18 is manipulated to place the brake switch 76 in the on-state, the process determines that the warning can be discontinued.

If it is determined in S250 that the warning can be discontinued, the process proceeds to S260 to discontinue the warning to the user by ending the warning process that was initiated in S200 or S220, and then proceeds to S270 to clear the stop-determination flag. The stop-determination flag is used for determining whether to apply an electric brake in the electric brake control process, which will be explained later.

After the stop-determination flag is cleared in S270, the process proceeds to S280 and executes the same stop process as executed in S210 to stop the motor 9 and ends the motor control process. The stop process to stop the motor 9 in S280 is also executed when it is determined in S230 that the warning is not in progress and when it is determined in S250 that the warning cannot be discontinued.

In the electric brake control process in FIG. 9, it is determined first in S310 whether the stop-determination flag, which is set and cleared in the motor control process, is set. If it is determined that the stop-determination flag is set, the process proceeds to S320 and determines whether the motor 9 is currently being driven. If the motor 9 is not being driven, the process proceeds to S330.

The process determines in S330 whether the rotational speed of the motor 9 is equal to or less than a predetermined set speed for determining application of the electric brake. If the rotational speed of the motor 9 is equal to or less than the predetermined set speed, the process proceeds to S340.

The process applies the electric brake (so-called short brake) in S340. The mechanism of the electric brake includes, for example, producing the damping torque in the motor 9 by causing short circuit in each windings in the motor 9 with the high-side switches Q1 to Q3 placed in the off-state and the low-side switches Q4 to Q6 placed in the on-state in the inverter 82.

The process causes the electric brake to be applied in S340 and proceeds to S350. The process also proceeds to S350 when it is determined in S310 that the stop-determination flag is cleared, when it is determined in S320 that the motor 9 is currently being driven, or when it is determined in S330 that the rotational speed of the motor 9 exceeds the predetermined set speed.

In S350, the process determines whether the electric brake is currently being applied by the procedure in S340. The process proceeds to S360 if the electric brake is currently being applied; the process ends the electric brake control process if the electric brake is not being applied.

In S360, the process determines whether the stop-determination flag is set. The process ends the electric brake control process if the stop-determination flag is set; the process proceeds to S370 if the stop-determination flag is not set.

In S370, the process releases the electric brake by placing the high-side switches Q1 to Q3 and the low-side switches Q4 to Q6 in the inverter 82 in the off-state to let the motor 9 be in a free-run state and ends the electric brake control process.

As it has been explained above, in the present embodiment, if the emergency motor-stop condition, which does not allow the drive of the motor 9 to be continued, is not fulfilled when it is determined to stop the drive of the motor 9 in response to fulfillment of the motor-stop condition during the drive of the motor 9, the drive of the motor 9 is continued only for a specified set time. During the length of the set time to continue the drive of the motor 9, the user is notified that the drive of the motor 9 will be stopped by the same warning process as executed when notifying that the motor 9 is already stopped.

The user can therefore be aware of and ready for the stop of the drive of the motor 9 before the drive of the motor 9 is actually stopped in response to fulfillment of the motor-stop condition.

Accordingly, when the motor-stop condition is fulfilled by an increase in load on the motor 9 during a carrying task on a slope for example, the user can be aware that the weight of the cart 1 will be placed on him as the drive of the motor 9 is stopped and take a defensive posture or activate the brake device 17. According to the present embodiment, usefulness of the cart 1 can therefore be improved.

The safety of the cart 1 can be secured since it is configured to determine that the emergency motor-stop condition of the drive of the motor 9 is fulfilled and immediately stop the drive of the motor 9 in an occurrence of a malfunction that does not allow the drive of the motor 9 to continue.

In addition, since it is configured to activate the electric brake in a case where the rotational speed of the motor 9 is equal to or less than the set speed when stopping the drive of the motor 9, an increase in load on the user due to a decrease in rotational speed of the motor 9 can be reduced when stopping the drive of the motor 9.

Furthermore, since the electric brake is configured to be released when the user manipulates the brake lever 18 and the stop-determination flag is accordingly cleared, the electric brake continues to be applied after the drive of the motor 9 is stopped until the mechanical brake is manipulated.

This can prevent the cart 1 from moving by its own weight when the electric brake is released on the slope. Usefulness of the cart 1 can therefore be improved also by this configuration.

Although one embodiment of the present disclosure has been described above, the electric push cart in the present disclosure is nevertheless not limited to the aforementioned embodiment and may be modified in various embodiments.

For example, in an example described in the aforementioned embodiment, the rotation of the front wheel 3, which is the driving wheel, is stopped by applying the electric brake to produce the damping torque in the motor 9 in a case where the rotational speed of the motor 9 is equal to or less than the predetermined set speed when stopping the drive of the motor 9 in the motor control process.

However, the purpose of such a brake control is only to reduce an increase of load on the user when the rotational speed of the motor 9 is decreased as the drive of the motor 9 is stopped. It is therefore not always necessary to produce a damping force in the motor 9. It may be configured so that the damping torque is produced directly on the front wheel 3, which is the driving wheel.

More specifically, it may be configured to dispose, for example, a braking mechanism, which can activate the brake device 17 by hydraulic pressure or other forces when the brake lever 18 is not manipulated, and produce a damping torque directly on the front wheel 3 by this braking mechanism if the rotational speed of the motor 9 is equal to or less than the predetermined set speed when stopping the drive of the motor 9 by the motor control process.

In an example described in the aforementioned embodiment, the cart 1 is a three-wheel cart having the left and right rear wheels 5L and 5R as coupled driving wheels. Nevertheless, the electric push cart of the present disclosure may be a unicycle that only includes a drive wheel that is rotationally driven by the motor. If the cart 1 is a unicycle, legs to support the cart 1 on the ground may be coupled to the rear wheel supports 7L and 7R in place of the left and right rear wheels 5L and 5R.

The configurations and movements of the electric push cart described in the aforementioned embodiment are only examples. The present disclosure may be used, in the same manner as described in the aforementioned embodiment, for any electric push carts that includes a wheel that is driven by a motor.

In addition, two or more functions of one element in the aforementioned embodiment may be achieved by two or more elements, or one function of one element in the aforementioned embodiment may be achieved by two or more elements. Similarly, two or more functions of two or more elements may be achieved by one element, or one function achieved by two or more elements may be achieved by one element. A part of the configurations of the aforementioned embodiment may be omitted. At least a part of the configurations of the aforementioned embodiment may be added to or replaced with another configurations of the aforementioned embodiment. It should be noted that any and all modes that are encompassed in the technical ideas that are defined only by the languages in the scope of the claims are embodiments of the present disclosure.

What is claimed is:

1. An electric push cart comprising:
a motor;
a drive wheel that is rotationally driven by the motor;
a cart frame that is configured to rotatably support the drive wheel and includes a handle for a user to hold in a rear end thereof; and
a controller that is configured to drive the motor, issue a warning in response to fulfillment of a motor-stop condition by an increase in load on the motor when driving the motor, and stops the drive of the motor after a given time has elapsed.

2. The electric push cart according to claim 1, wherein the controller is configured to detect a loaded state of the motor based on at least one of a state of current conduction to the motor, a rotating state of the motor, or a temperature of the motor, and determine whether the motor-stop condition is fulfilled.

3. The electric push cart according to claim 1, wherein the controller is configured to determine whether to execute a brake control, which produces a damping torque on the drive wheel, depending on a rotating state of the motor when stopping the drive of the motor in response to fulfillment of the motor-stop condition.

4. The electric push cart according to claim 3, wherein the controller is configured to execute the brake control in a case where a rotational speed of the motor is equal to or less than a specified threshold value when stopping the drive of the motor in response to fulfillment of the motor-stop condition.

5. The electric push cart according to claim 1, wherein the controller is configured to immediately stop the drive of the motor in response to fulfillment of an emergency motor-stop condition when driving the motor.
